(19) United States
(12) Patent Application Publication
(10) Pub. No.: US 2018/0302720 A1
(43) Pub. Date: Oct. 18, 2018

(54) Carbon Fiber Dome

(71) Applicant: AAC Technologies Pte. Ltd., Singapore city (SG)

(72) Inventors: Xun Di, Shenzhen (CN); Bin Zhao, Shenzhen (CN)

(21) Appl. No.: 15/646,852

(22) Filed: Jul. 11, 2017

(30) Foreign Application Priority Data
Apr. 13, 2017 (CN) 201710237836.7

(51) Int. Cl. H04R 7/12; B32B 5/18; B32B 5/02; B32B 37/14; H04R 31/00; C08J 5/24

(52) U.S. Cl. CPC H04R 7/127; B32B 5/18; B32B 5/02; B32B 37/14; H04R 2307/023; C08J 5/24; B32B 2307/10; B32B 2309/105; B32B 2305/076; H04R 31/003

(57) ABSTRACT

The present disclosure provides a carbon fiber dome. The carbon fiber dome includes a foam material layer; a first carbon fiber layer at an upper surface of the foam material layer and/or a second carbon fiber layer at an lower surface of the foam material layer. The first carbon fiber layer and/or the second carbon fiber layer includes one or more layers of unidirectional carbon fiber prepreg tapes. The present disclosure further provides a manufacturing method for making such a carbon fiber dome described above.

### CROSS-REFERENCE TO RELATED APPLICATIONS

This application claims the priority benefit of Chinese Patent Application Ser. No. 201610398572.9 filed on Jun. 7, 2016, the entire content of which is incorporated herein by reference.

### FIELD OF THE PRESENT DISCLOSURE

The present disclosure relates to electro-acoustic transducers, more particularly to a carbon fiber dome for radiating audible sounds.

### DESCRIPTION OF RELATED ART

A loudspeaker generally includes a diaphragm for radiating sounds. The diaphragm typically includes a dome part and a suspension connecting with and supporting the dome. The dome part of the vibrating diaphragm is commonly made of an aluminum foil-foam material composite. With the development of the electronic industry, there are demands for higher performance and reliability of the electro-acoustic system and increasingly higher requirements for domes. The domes of aluminum foil-foam material composites can no longer meet user's needs due to such frequent problems as the aluminum foil splinters easily, the foam material is separated from the aluminum foil, and the materials have inadequate strength. From other aspect, the flexible aluminum foil, as the intuitive and visible part of products, are liable to contamination, scratching and other damages to appearance; the foam material is liable to deformation under stress and difficult to recover its original shape once deformed, and it has a strong water absorptivity, tending to cause the aluminum foil and the foam material to be separated from each other.

Therefore it is necessary to provide an improved dome part for overcoming the above-mentioned disadvantages.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present disclosure.

FIG. 1 is an illustration of a carbon fiber dome in accordance with an exemplary embodiment of the present disclosure.

FIG. 2 is an illustration of a carbon fiber dome with a single-layer configuration.

FIG. 3 is an illustration of a carbon fiber dome with a multi-layer configuration.

FIG. 4 is an illustration of a carbon fiber dome with a multi-layer configuration in accordance with another exemplary embodiment.

FIG. 5 is an illustration of a carbon fiber dome with a multi-layer configuration in accordance with another exemplary embodiment.

FIG. 6 is an illustration of a carbon fiber dome in accordance with another exemplary embodiment of the present disclosure.

FIG. 7 is a flow chart of a manufacturing method for making the carbon fiber dome of the present disclosure.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

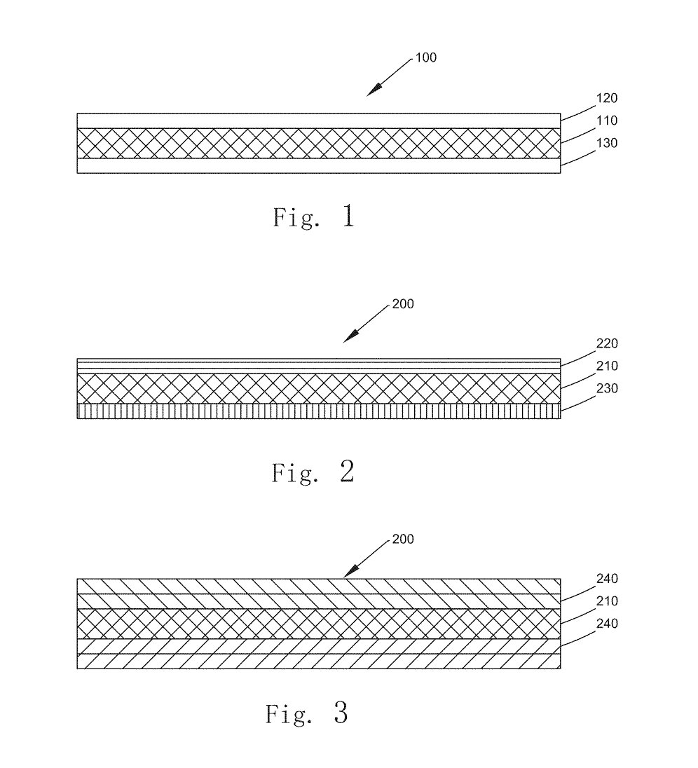

The present invention discloses a dome made of carbon fiber to overcome the problems of domes in the prior art that are liable to splintering, delamination and inadequate strength and poor appearance. As shown in FIG. 1, the carbon fiber dome 100 disclosed in one embodiment of the present invention comprises a foam material layer 110, a first carbon fiber layer 120 on the upper end face of the foam material layer 110 and/or a second carbon fiber layer 130 on the lower end face of the foam material layer 110. The carbon fiber dome in the embodiment of the present invention may have the foam material layer 110 provided with the carbon fiber layer on one side or both sides to further improve its performance and combination performance, wherein the first carbon fiber layer 120 and/or the second carbon fiber layer 130 comprise one or more layers of unidirectional carbon fiber prepreg tapes. The dome is unidirectionally stressed in the environment in which the present invention is utilized, so the provision of unidirectional carbon fiber tapes with an excellent uni-directional stressing characteristic satisfies the stressing requirements of the dome; besides, the unidirectional carbon fiber prepreg tapes utilized in the present invention can be bonded to the foam material layer 110 without use of any extra adhesive thanks to the stickiness of the unidirectional carbon fiber prepreg tapes. Following the bonding, the assembly is treated at a high temperature and under a high pressure in such a way that the prepreg resin in the unidirectional carbon fiber prepreg tapes is cured, further enhancing the strength of the bonding and therefore providing a more tighter bonding, further increasing the strength of the unidirectional carbon fiber prepreg tapes, guaranteeing the stressing strength of the dome and improving the high frequency performance of the dome by virtue of the cured resin. Besides, the use of carbon fiber reduces the overall thickness of the dome, provides vibrating performance, guarantees the sound quality and allows products to occupy less space. In addition, the curing of the resin in the unidirectional carbon fiber prepreg tapes gives a smooth surface of the dome, and the hard resin after the curing is not easily scratched, making the carbon fiber dome 100 more attractive.

The foam material layer in the embodiment of the present invention is made of one or more of polymethacrylimide (PMI), foam polyphenylene sulfide (PPS), microcellular foam plastics (MCP), and expanded polypropylene (PP), and selected for use among them based on the acoustic vibration range and the stressing range.

The uni-directional carbon fiber prepreg tapes in the embodiment of the present invention comprise a carbon fiber material and a prepreg resin, the uni-directional carbon fiber prepreg tapes can bear a great force in the direction of fiber extension, i.e. the fiber direction, but bear a lower force in the direction perpendicular to the fiber direction. However, the curing with the resin significantly improves its capacity of bearing the force. Specifically, the prepreg resin comprises, one or more of epoxy resin, poly(ether-ether-ketone) (PEEK), polyimide (PI), polyphenylene sulfide (PPS), poly (p-phenylenebenzobisoxazole) (PBO), poly-p-phenylene terephthamide (Aramid fiber 1414); the tensile modulus of the carbon fiber material is greater than 200 Gpa, and the carbon fiber material is the amorphous graphite material obtained by the process that organic fibers including flake graphite crystallite are packed along the axial direction of the fiber and then carbonized and graphitized. The carbon fiber is apparently flexible and intrinsically rigid, and lighter than the aluminum, and it has a greater strength than the steel iron, and possesses the characteristics of corrosion resistance and high modulus. In practice, above T300 of the T series and all models of the M series and other series with the same strength class produced by TORAY as well as the materials of other suppliers can be used. It should be noted that the T series and the M series of TORAY are the models of the TORAY's carbon fibers and belong to the industrial standards, so those skilled in the field are readily accessible to both series of materials. In this way, the mechanical characteristics of the dome of the present invention is substantially enhanced, while both the weight and the thickness are reduced. The thickness of the carbon fiber dome of the embodiment of the present invention is 40˜400 μm, and preferably 80˜200 μm. Compared with the dome made of the aluminum foil, the dome of the present invention is much thinner and has a better acoustic vibration characteristic.

In accordance with the present invention, the carbon fiber dome may have the foam material layer provided with one or more layers of uni-directional carbon fiber prepregs on one side or both sides. As shown in FIG. 2, some embodiments of the present invention disclose a carbon fiber dome 200 comprising a foam material layer 210, a first uni-directional carbon fiber prepreg tapes 220 on the upper end face of the foam material layer 210 and/or a second uni-directional carbon fiber prepreg tapes 230 on the lower end face of the foam material layer 210. The provision of the carbon fiber prepregs on the upper end face and on the lower end face of the foam material layer gives the carbon fiber dome a symmetrical mechanical characteristic which can prevent sound interference or resonance.

In order to further guarantee the sufficient strength of the dome and its applicability to many mechanical and acoustic requirements, the first carbon fiber layer 120 and/or the second carbon fiber layer 130 comprise mutilple layers of unidirectional carbon fiber prepreg tapes.

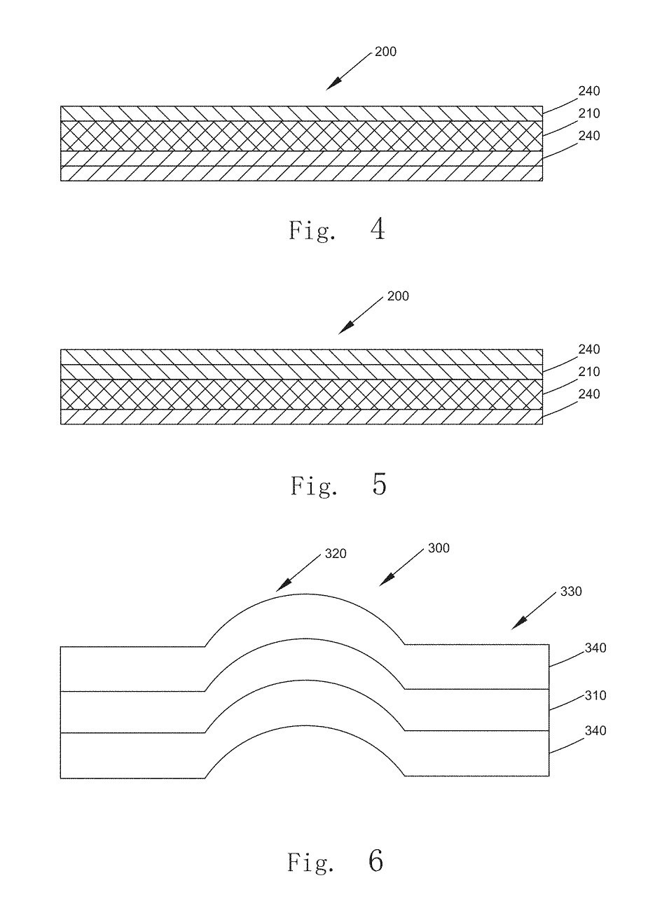

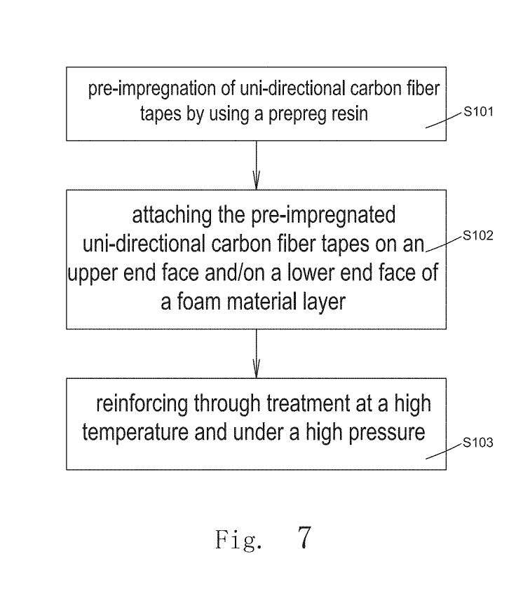

As shown in FIGS. 3, 4 and 5, some embodiments of the present invention provide a carbon fiber dome 200 with multiple layers of unidirectional carbon fiber prepreg tapes which comprises a middle foam material layer 210 and multiple layers of unidirectional carbon fiber prepreg tapes 240 on either side of the foam material layer 210. The superimposed combination of the unidirectional carbon fiber prepreg tapes 240 layer by layer on either side of the foam material layer 210 enhances the mechanical characteristic, but too great thickness will weaken the acoustic vibration performance, so the thickness of the carbon fiber dome 200 in the embodiment of the present invention is 80˜200 μm, thus guaranteeing the mechanical strength, the acoustic vibration performance and the sound frequency range. In FIG. 3, either side of the foam material layer 210 has two or more layers of unidirectional carbon fiber prepreg tapes 240. In FIGS. 4 and 5, the foam material layer 210 has one and two or more layers of unidirectional carbon fiber prepreg tapes 240 respectively on its two sides, which is determined based on needs.

The included angle of the fiber directions of the uni-directional carbon fiber prepreg tapes 240 in different layers is 0 degree˜90 degrees, which guarantees the stressing characteristic of the carbon fiber dome in various directions. For example, in FIG. 3, the multiple layers of uni-directional carbon fiber prepreg tapes 240 on either side can be set as 0 degree and 90 degrees; in case of three layers on either side, 0 degree, 45 degrees and 90 degrees can be set; the angle is equalized layer by layer if the layers are increased, guaranteeing the stressing in various directions. Besides, the layers of uni-directional carbon fiber prepreg tapes on the upside and downside of the foam material layer in the embodiment can be arranged by the principle of fiber angle complementation, i.e. if the fiber angle on the upside is 0 degree, then the angle on the downside is 90 degrees; if the fiber angle on the upside is 0 degree, 45 degrees and 90 degrees, then the angle on the downside is 0 degree, 45 degrees (perpendicular with the 45 degrees on the upside) and 90 degrees, thus guaranteeing uniform and symmetrical stress on the upside and the downside.

The dome in the present invention may be plate-shaped or have a hemispherical structure. Specifically, the carbon fiber dome can also be designed as a hemispherical structure to further improve the high frequency performance. As shown in FIG. 6, some embodiments of the present invention disclose a carbon fiber dome 300 which comprises a foam material layer 310 and uni-directional carbon fiber prepreg tapes 340 on both sides of the foam material layer 310, wherein the uni-directional carbon fiber prepreg tapes 340 and the foam material layer are made into the dome through treatment at a high temperature and under a high pressure. The dome comprises a convex hull-shaped structure 320 and a plate-shaped structure 330, wherein the plate-shaped structure is provided around the convex hull-shaped structure.

Once the carbon fiber dome of the present invention is formed, it is cut into a desired shape by such technologies as the laser cutting, cutting by a trimming die and die-cutting by a die-cutting machine, bonded with the membrane by application of gum, gluing and other methods to form a vibration assembly, and assembled into a loudspeaker at last.

In accordance with another aspect of the present invention, a manufacturing method is disclosed to manufacture a carbon fiber dome with both a fine appearance and mechanical and acoustic performance. The manufacturing method features a reliable and simple process, and the dome made by the method has an excellent performance. Specifically, as shown in the FIG. 7, the embodiment of the present invention discloses a manufacturing method of the carbon fiber dome which includes the following steps: S101, a prepreg resin is used to pre-impregnate uni-directional carbon fiber tapes; S102, pre-impregnated uni-directional carbon fiber tapes are attached on the upper end face and/on the lower end face of the foam material layer without use of any extra adhesive thanks to the stickiness of the pre-impregnated uni-directional carbon fiber tapes; and then S103, through treatment at a high temperature and under a high pressure, the unidirectional carbon fiber tapes can be bonded tightly to the foam material layer, featuring a reliable and simple process. The prepreg resin comprises one or more of epoxy resin, poly(ether-ether-ketone) (PEEK), polyimide (PI), polyphenylene sulfide (PPS), poly (p-phenylenebenzobisoxazole) (PBO) and poly-p-phenylene terephthamide (Aramid fiber 1414).

Further, the attaching of the pre-impregnated uni-directional carbon fiber tapes on the upper end face and/or on the lower end face of the foam material layer includes sticking one or more layers of the pre-impregnated uni-directional carbon fiber tapes on the upper end face and/or on the lower end face of the foam material layer. The bonding is realized layer by layer, so it is easy to control the thickness.

Further, in sticking the uni-directional carbon fiber tapes, the fiber directions of the uni-directional carbon fiber prepreg tapes in different layers are set as 0 degree˜90 degrees, which guarantees the stressing characteristic of the dome in various directions

In accordance with the manufacturing method of the dome in the present invention, a composite layer can be formed by a simple sticking, and reinforced through treatment at a high temperature and under a high pressure to obtain the dome with excellent mechanical and acoustic performance while having a fine appearance. The manufacturing method in the embodiment is simple and easy to operate, and has a low requirement for the equipment, so it enjoys a prospect of a wide application.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

1. A carbon fiber dome, comprising:
a foam material layer;
a first carbon fiber layer at an upper surface of the foam material layer and/or a second carbon fiber layer at an lower surface of the foam material layer;
wherein
the first carbon fiber layer and/or the second carbon fiber layer comprise one or more layers of unidirectional carbon fiber prepreg tapes;
the uni-directional carbon fiber prepreg tapes comprise a carbon fiber material and a prepreg resin, the prepreg resin comprises one or more of poly (p-phenylenebenzobisoxazole) and poly-p-phenylene terephthamide.

2. The carbon fiber dome as described in claim 1, wherein, an included angle of the fiber directions of the uni-directional carbon fiber prepreg tapes in different layers is 0 degree˜90 degrees.

3. The carbon fiber dome as described in claim 1, wherein, a thickness of the carbon fiber dome is 40˜400 μm.

4. The carbon fiber dome as described in claim 3, wherein, the thickness of the carbon fiber dome is 80˜200 μm.

5. The carbon fiber dome as described in claim 1, wherein, the foam material layer is made of one or more of polymethacrylimide, foam polyphenylene sulfide and
microcellular foam plastics.

6. The carbon fiber dome as described in claim 1, wherein, the tensile modulus of the carbon fiber material is greater than 200 Gpa.

7. (canceled)

8. A method for manufacturing the carbon fiber dome described in claim 1 including the following steps:
pre-impregnation of uni-directional carbon fiber tapes by using a prepreg resin;
attaching the pre-impregnated uni-directional carbon fiber tapes on an upper end face and/on a lower end face of a foam material layer.

9. The method for manufacturing the carbon fiber dome as described in claim 8, wherein, the step of attaching the pre-impregnated uni-directional carbon fiber tapes on the upper end face and/or on the lower end face of the foam material layer includes sticking one or more layers of the pre-impregnated uni-directional carbon fiber tapes on the upper end face and/or on the lower end face of the foam material layer.

10. The method for manufacturing the carbon fiber dome as described in claim 8, wherein, the fiber directions of the uni-directional carbon fiber prepreg tapes in different layers are set as 0 degree˜90 degrees.
